(19) United States
(12) Patent Application Publication
(10) Pub. No.: US 2002/0099575 A1
(43) Pub. Date: Jul. 25, 2002

(54) System and method for managing rentals from a rental service provider

(76) Inventors: Donald Bruce Hubbard, Hudson, OH (US); Daniel Lee Betting, Strongsville, OH (US)

Correspondence Address: Kirk D. Houser, Eckert Seamans Cherin & Mellott, LLC, 44th Floor, 600 Grant St., Pittsburgh, PA, 15219, US

(21) Appl. No.: 09/766,550

(22) Filed: Jan. 19, 2001

(51) Int. Cl. G06F 17/60

(52) U.S. Cl. 705/5

(57) ABSTRACT

A system manages vehicle rentals from a service provider for a plurality of users, such as claims adjusters or claims managers. The system includes a server having a routine and a database with vehicle rental variables associated with each of the rentals, a plurality of client systems for the users, and a global communication network, such as the Internet, interconnecting the server with the client systems. Each client system includes a data entry component selecting one of the variables, entering a value corresponding to the selected variable, and entering a request for a report based upon the value and the selected variable. The network sends the request from one of the client systems to the server. The routine generates the report for at least one of the rentals for which the selected variable differs from the entered value. The network sends the report to the requesting one of the client systems.

### BACKGROUND OF THE INVENTION

1. Field of the Invention

The present invention relates to a system and method for managing rentals and, more particularly, to a system and method for managing vehicle rentals of a vehicle rental service provider over a communication channel or network, such as the Internet.

2. Background Information

The Internet comprises a vast number of computers and computer networks that are interconnected through communication links. The interconnected computers exchange information using various services, such as electronic mail (i.e., e-mail), and the World Wide Web (“WWW”). The WWW service allows a server computer system (e.g., a web server, a web site) to send graphical web pages of information to a remote client computer system. The remote client computer system can then display the web pages. Each resource (e.g., computer, web page) of the WWW is uniquely identifiable by a Uniform Resource Locator (“URL”). To view a specific web page, a client computer system specifies the URL for that web page in a request (e.g., a HyperText Transfer Protocol (“HTTP”) request). The request is forwarded to the web server that supports that web page. When that web server receives the request, it sends that web page to the client computer system. When the client computer system receives that web page, it typically displays the web page using a browser. A browser is a special-purpose application program that effects the requesting of web pages and the displaying of web pages.

Currently, web pages are typically defined using HyperText Markup Language (“HTML”). HTML provides a standard set of tags that define how a web page is to be displayed. When a user indicates to the browser to display a web page, the browser sends a request to the server computer system to transfer to the client computer system an HTML document that defines the web page. When the requested HTML document is received by the client computer system, the browser displays the web page as defined by the HTML document. The HTML document contains various tags that control the displaying of text, graphics, controls, and other features. The HTML document may contain URLs of other web pages available on that server computer system or other server computer systems.

The World Wide Web is especially conducive to conducting electronic commerce (i.e., e-commerce). Many web servers have been developed through which vendors can advertise various goods and services for sale or rental.

It is known to employ an electronic rental management system using private frame relay connections for communication. Such a system was employed to permit a vehicle rental service provider to provide an insurance claims center of an insurance company with a direct electronic connection to the vehicle rental service provider's branch locations. Such a system employed data entry, which was usually accomplished by the vehicle rental service provider's employee based within the insurance claims center. This system permitted the vehicle rental service provider's field office to print rental invoices and mail the same to the insurance company. In turn, the printed invoices were physically routed to the paying party (e.g., the appropriate claims adjuster in the claims center). The system employed one input/output terminal at the claims center and required one individual (e.g., a rental coordinator) to input data and route requests, invoices, and the like to the appropriate party within the claims center. Hence, individual claims adjusters had to either go get the printed invoice (although they had no direct way of knowing it was even available) or get someone to bring it to them.

The foregoing electronic rental management system also employed a search feature. An individual, such as a claims adjuster, had to request that the rental coordinator conduct the search and relay the requested information back to the claims adjuster. For example, if a claims adjuster was on the telephone with a claimant or insured who asked a question regarding their rental bill, then the claims adjuster would have to call the rental coordinator, relay the question request, and wait for the response while the rental coordinator initiated the search. Then, in order for the claims adjuster to fix a rental problem, the adjuster would have to receive a bill, review it, note a problem with the bill, go back to the person who submitted it, and seek to adjust the problem.

FIG. 1 shows a display 2 of the prior electronic rental management system including a scoreboard 4 for pending reservations, working rentals, closed rentals, incoming messages, and invoices.

FIG. 2 shows a display 6 of the prior electronic rental management system including a reservation wizard having a phone number routing screen 8.

FIG. 3 shows a display 10 of the prior electronic rental management system including a reservation information screen.

FIG. 4 shows a display 12 of the prior electronic rental management system including a search screen, which employed search terms including “Reso” (Reservation) number 14, Bill To 16 (claims adjuster's name), renter's First Name 18, renter's Last Name 20, rental Date Out 22, rental Date In 24, Contract Number 26, Status 28 (i.e., Pending, Active, Invoiced), claim number 30, and branch Office Number 32. The displayed search results include an indication of Renter Type (i.e., Insured (I), and claimant (C)) 34.

FIG. 5 shows a display 36 of the prior electronic rental management system including a “working rentals” search screen, which employed similar search terms as in FIG. 4, except that rental Date In 24 (FIG. 4) is not active, and Contract Status 28 was either Active or Terminated.

FIG. 6 shows a display 38 of the prior electronic rental management system including an “incoming messages” screen. Each message, such as 40, could be acknowledged or printed by the rental coordinator through buttons 42 or 44, respectively.

FIG. 7 shows a display 46 of the prior electronic rental management system including a “closed rentals” screen, which employed similar search terms as in FIG. 4, except that Contract Status 28 was Invoiced.

FIG. 8 shows a display 48 of the prior electronic rental management system including an “available reports” screen, which included searches for billed rentals without details 50, billed rentals with details 52, pending reservations 54, and working contracts 56. Summary 58 or detail 60 reports could be requested for the entire vehicle rental service provider 62, by a selected claims office 64, and by a selected claims adjuster 66. Also, a time period to be covered by the report could be specified including today 68, this month 70, this year 72, and a selected range 74 of dates 76.

There is room for improvement in systems and methods for managing vehicle rentals.

### SUMMARY OF THE INVENTION

The present system and method permit online access of rental claim information by a plurality of users, such as claims adjusters or claims managers, at an insurance service provider, such as an insurance company.

According to one aspect of the present invention, a method for managing rentals from a rental service provider by an insurance service provider having a plurality of claims adjusters and claims managers comprises: employing a server system including a database having rental claim information for each of the rentals; employing a plurality of client systems for the claims adjusters and the claims managers; employing a global communication network to interconnect the server system with the client systems; displaying at least some of the rental claim information for one of the rentals at one of the client systems; modifying the rental claim information for the one of the rentals from the one of the client systems; and reviewing by exception some of the rental claim information from another one of the client systems.

According to a further aspect of the invention, a method for managing vehicle rentals from a vehicle rental service provider for a plurality of users comprises: employing a server system including a database having vehicle rental variables for the vehicle rentals; employing a plurality of client systems for the users; employing a global communication network for interconnecting the server system with the client systems; selecting one of the vehicle rental variables; entering a value corresponding to the selected one of the vehicle rental variables; and generating a report for at least one of the vehicle rentals for which the selected one of the vehicle rental variables differs from the entered value.

According to another aspect of the invention, a system for managing vehicle rentals from a vehicle rental service provider for a plurality of users comprises: a server system including a routine and a database having vehicle rental variables associated with each of the vehicle rentals; a plurality of client systems for the users, each of the client systems including a data entry component selecting one of the vehicle rental variables, entering a value corresponding to the selected one of the vehicle rental variables, and entering a request for a report based upon the value and the selected one of the vehicle rental variables; and a global communication network interconnecting the server system with the client systems, the global communication network sending the request from one of the client systems to the server system, the routine of the server system generating the report for at least one of the vehicle rentals for which the selected one of the vehicle rental variables differs from the entered value, the global communication network sending the report to the one of the client systems.

### BRIEF DESCRIPTION OF THE DRAWINGS

A full understanding of the invention can be gained from the following description of the preferred embodiments when read in conjunction with the accompanying drawings in which:

FIG. 1 is a representation of a display including a scoreboard for pending reservations, working rentals, closed rentals, incoming messages, and invoices.

FIG. 2 is a representation of a display including a reservation wizard having a phone number routing screen.

FIG. 3 is a representation of a display including a reservation information screen.

FIG. 4 is a representation of a display including a search screen.

FIG. 5 is a representation of a display including a “working rentals” search screen.

FIG. 6 is a representation of a display including an “incoming messages” screen.

FIG. 7 is a representation of a display including a “closed rentals” screen.

FIG. 8 is a representation of a display including an “available reports” screen.

FIG. 9 is a block diagram of a system in accordance with the present invention.

FIG. 10 is a block diagram of a server system, including Internet connections, in accordance with an embodiment of the present invention.

FIG. 11 is a representation of a home page of a vehicle rental management system.

FIG. 12 is a representation of an express reservation form.

FIGS. 13A-13C are representations of three full reservation forms.

FIG. 14A is a representation of an open vehicle rentals listing.

FIGS. 14B and 14C are representations of pop-up windows for the listing of FIG. 14A.

FIG. 15A is a representation of a pending, reservations listing.

FIGS. 15B-15D are representations of pop-up windows associated with the listing of FIG. 15A.

FIG. 16 is a representation of a search screen.

FIG. 17A is a representation of a report screen.

FIGS. 17B-17D are representations of pop-up windows associated with the screen of FIG. 17A.

FIG. 17E is a representation of the report screen of FIG. 17A including user selections and entries.

FIG. 17F is a representation of an open rentals report.

FIG. 17G is a representation of further details of the report screen of FIG. 17A.

FIG. 17H is a representation of a summary report.

FIG. 17I is a representation of a detail report.

FIGS. 18A-18H are diagrams of the system login process, the reservation process, the vehicle rental process, the extension process, the vehicle rental closing process, the reservation cancellation process, the search process, and the report process.

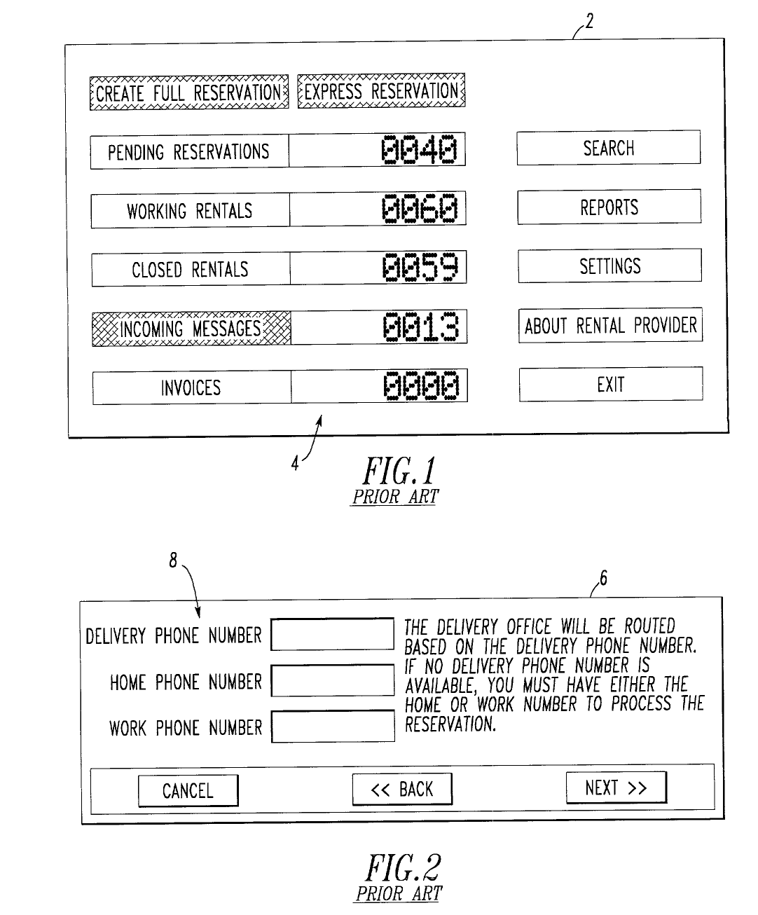

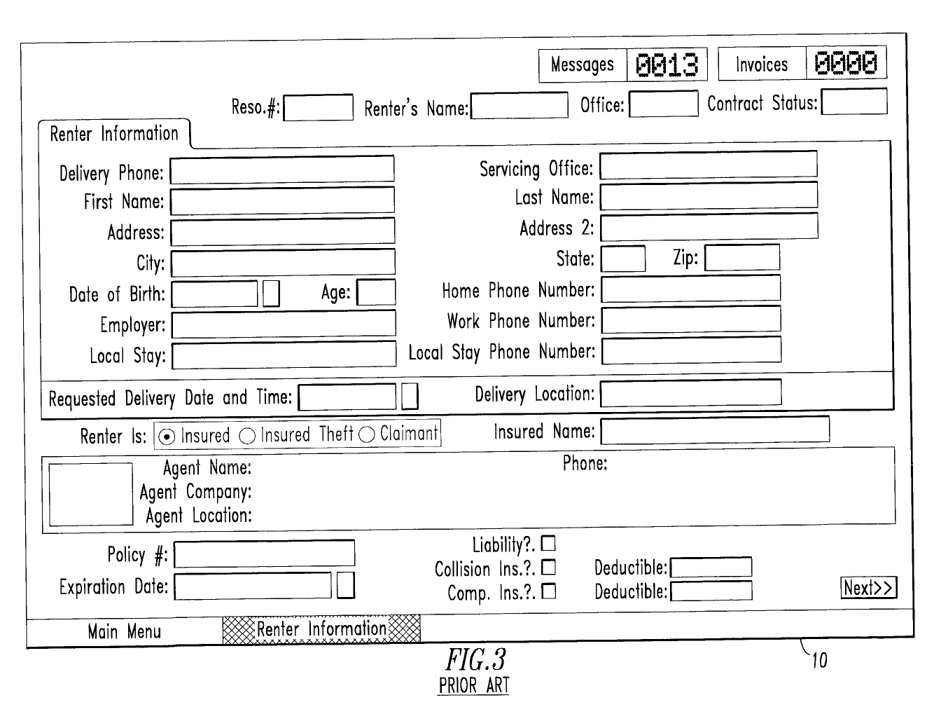

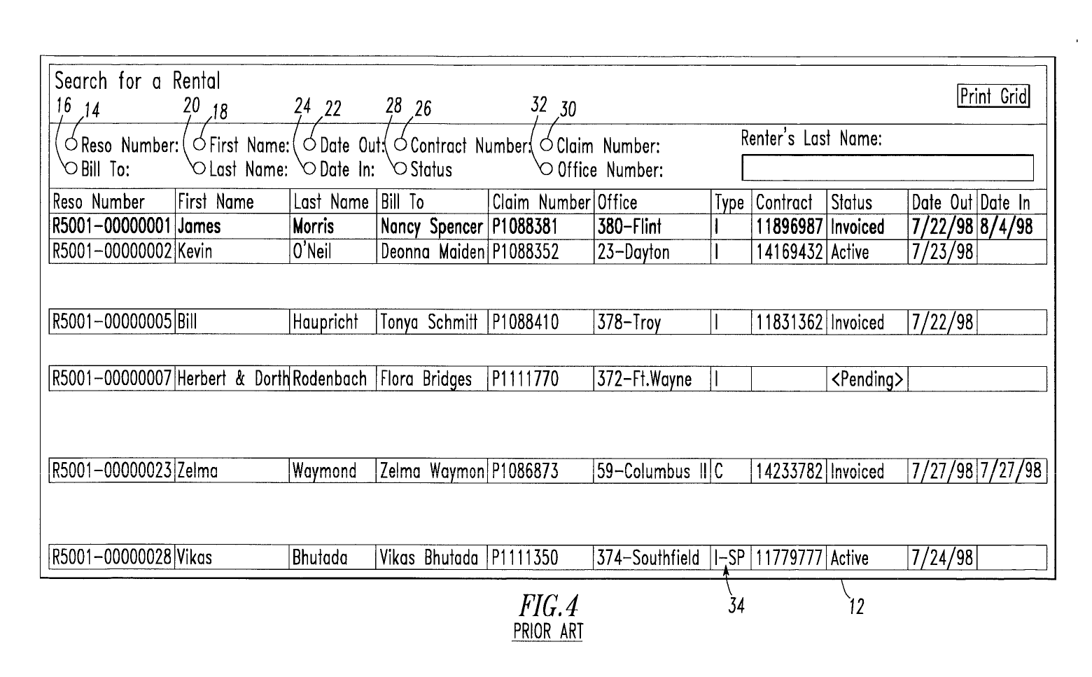

### DESCRIPTION OF THE PREFERRED EMBODIMENTS

As employed herein, the term “vehicle” shall expressly include, but not be limited to, any new or used vehicle having pneumatic tires, such as, for example, land-based vehicles, automobiles, cars, trucks, sport utility vehicles (SUVs), vans, motorcycles, mopeds, campers, trailers, and bicycles.

As employed herein, the term “communication network” shall expressly include, but not be limited to, any local area network (LAN), wide area network (WAN), intranet, extranet, wireless communication system, global communication network, and the Internet.

As employed herein, the term “HTML” shall expressly include, but not be limited to, HTML, dHTML (dynamic HTML), and other suitable technologies to produce a web page.

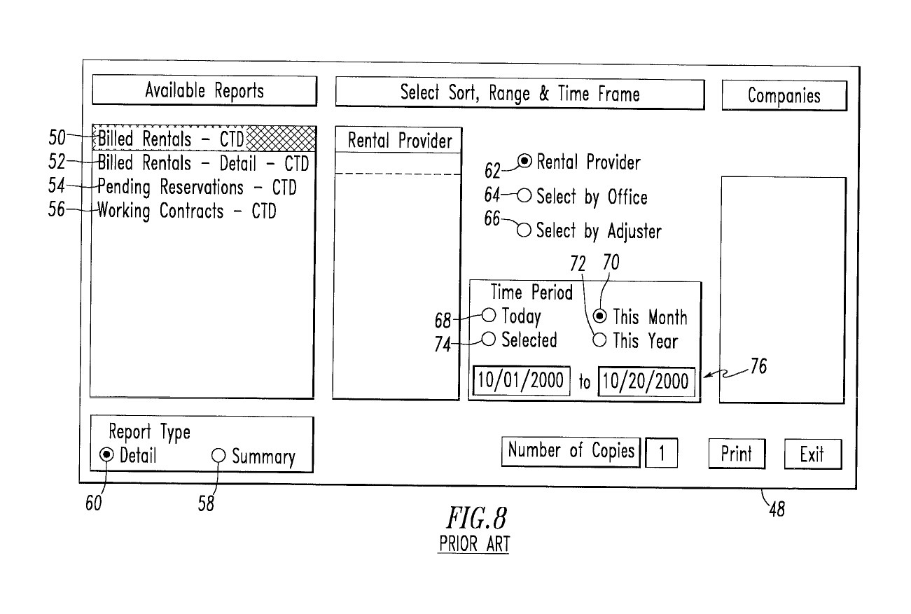

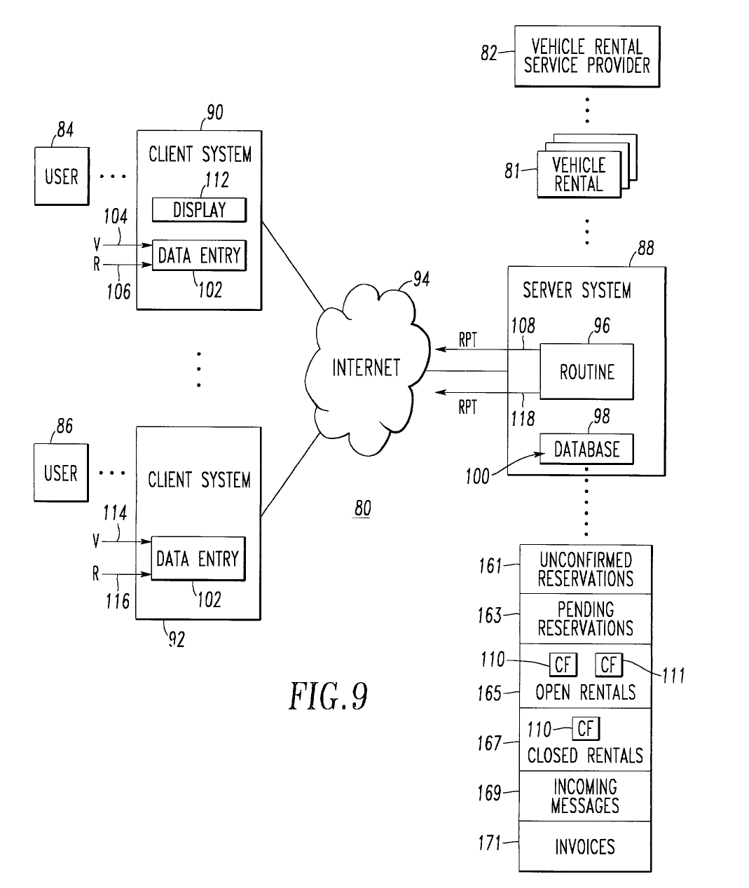

FIG. 9 shows an exemplary client-server system 80 in accordance with the present invention. The system 80 manages exemplary vehicle rentals 81 from a vehicle rental service provider 82 for a plurality of users 84,86. The system 80 includes a server system 88, a plurality of client systems 90,92 (e.g., personal computers (PCs)) for the respective users 84,86, and a global communication network 94, such as the exemplary Internet, which interconnects the server system 88 with the client systems 90,92. The server system 88 includes a routine 96 and a database 98 having vehicle rental variables 100 associated with each of the vehicle rentals 81. Each of the client systems 90,92, such as 90, includes a data entry component 102, which selects one of the vehicle rental variables 100, enters a value (V) 104 corresponding to the selected one of the vehicle rental variables 100, and enters a request (R) 106 for a report (RPT) 108 based upon the value 104 and the selected one of the vehicle rental variables 100. The global communication network 94 sends the request 106 from one of the client systems 90,92, such as 90, to the server system 88. In turn, the routine 96 of the server system 88 generates the report 108, and the global communication network 94 sends the report 108 to the requesting one of the client systems 90,92. In the exemplary embodiment, the report 108 is generated for at least one of the vehicle rentals 81 for which the selected one of the vehicle rental variables 100 differs from (e.g., is greater than; is less than) the entered value 104. Alternatively, the user may request a report for which the selected one of the vehicle rental variables 100 is equal to the entered value 104.

As one application of the exemplary system 80, the users 84,86 are claims adjusters and claims managers of an insurance service provider (e.g., a vehicle insurance company), which users employ the system 80, in order to manage vehicle rentals from the vehicle rental service provider 82. The database 98 has rental claim information 110 (or claim files (CF)), including the vehicle rental variables 100, for the vehicle rentals 81. A claims adjuster, such as user 84, employs the client system 90 to display at least some of the rental claim information 110 for one of the vehicle rentals 81 on the display 112 of the client system 90. In turn, that user 84 may modify that rental claim information 110 for the particular one of the vehicle rentals 81 from that client system 90. In accordance with a preferred practice of the invention, another user 86, such as a claims manager, may review by exception some of the rental claim information 110 from another client system, such as 92. For example, the claims manager selects one of the vehicle rental variables 110, enters a value (V) 114 corresponding to the selected one of the vehicle rental variables 100, and responsive to a request (R) 116, the server routine 96 generates a report (RPT) 118 for at least one of the vehicle rentals 81 for which the selected one of the vehicle rental variables 100 differs from (e.g., is greater than; is less than) the entered value 114.

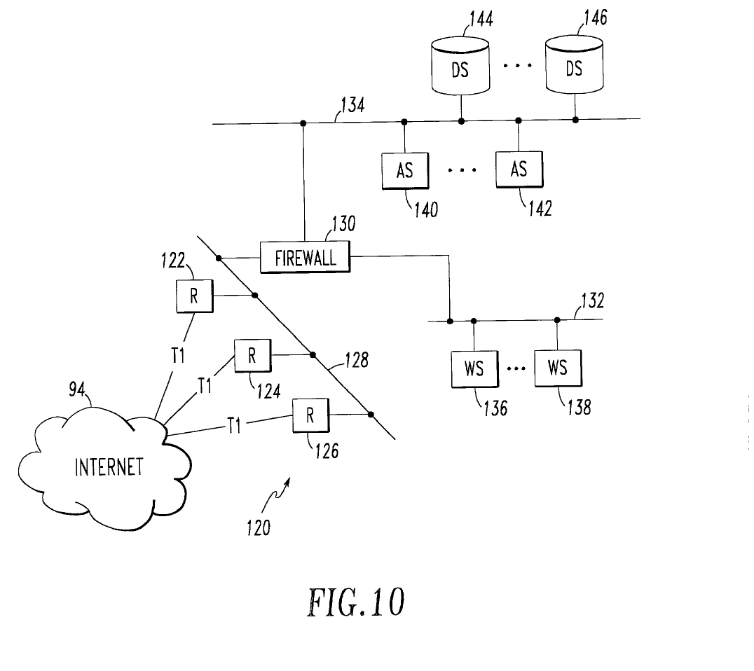

Referring to FIG. 10, a vehicle rental management server system 120 and three exemplary T1 Internet connections 122,124,126 to the Internet 94, are shown. The exemplary server system 120 includes an Internet segment network 128, a firewall 130, a DMZ (de-militarized zone) network 132, and a corporate network 134. The exemplary system 120 is an n-tier server architecture including one or more web servers (WS) 136,138, one or more application servers (AS) 140,142, and one or more database servers (DS) 144,146. The exemplary web servers 136,138 run Microsoft's Internet Information Server (IIS), facilitate page requests for user login, and pass Java Server Pages (JSP) generated and processed by the application servers 140,142. The exemplary application servers 140,142 run BEA's WebLogic application server technology. WebLogic is a Java technology application platform facilitating highly available, fault tolerant, highly scalable, and redundant delivery. The exemplary database servers 144,146 run Oracle's Database Server version 8i. The system 120 preferably employs 128 bit SSL (secure socket layer) encryption, which enables users to securely communicate with a relatively high level of data encryption.

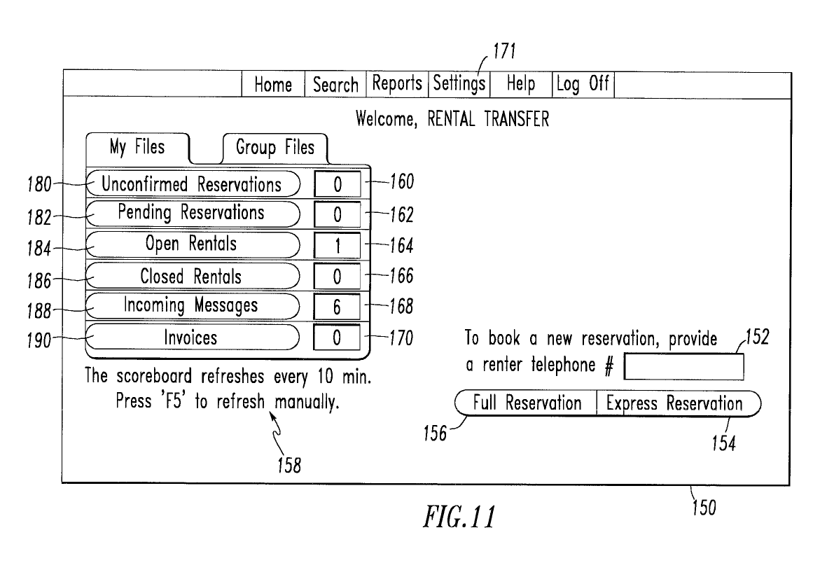

Initially, a claims adjuster enters a user name and password on a login page (not shown) of a vehicle rental management system, such as provided by the server systems 88,120 of respective FIGS. 9 and 10. This permits user access to a personal home page, such as the home page 150 of FIG. 11. The user's home page 150 permits management of the user's vehicle rentals from the vehicle rental service provider, such as 82 of FIG. 9, including entering new rental reservations, obtaining current rental statuses, and obtaining invoicing or reporting information. From the home page 150, the user can view and manage open or closed rentals. Also, claims managers can monitor account information, while claims adjusters, supervisors, and other management can receive exception information, as it occurs, throughout the territory of the vehicle rental service provider.

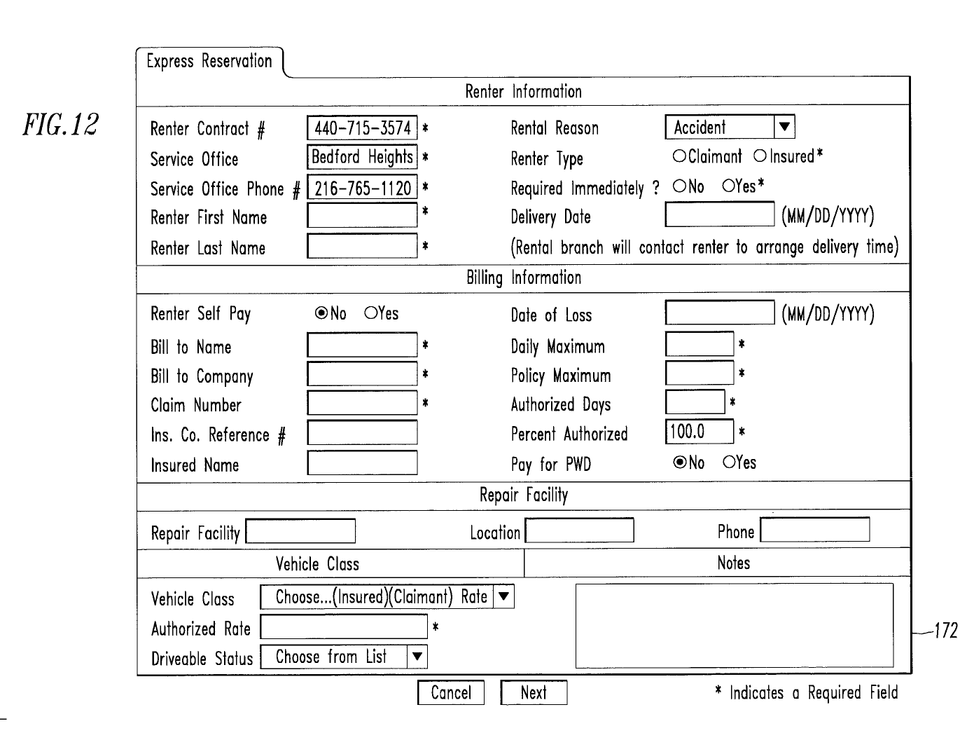

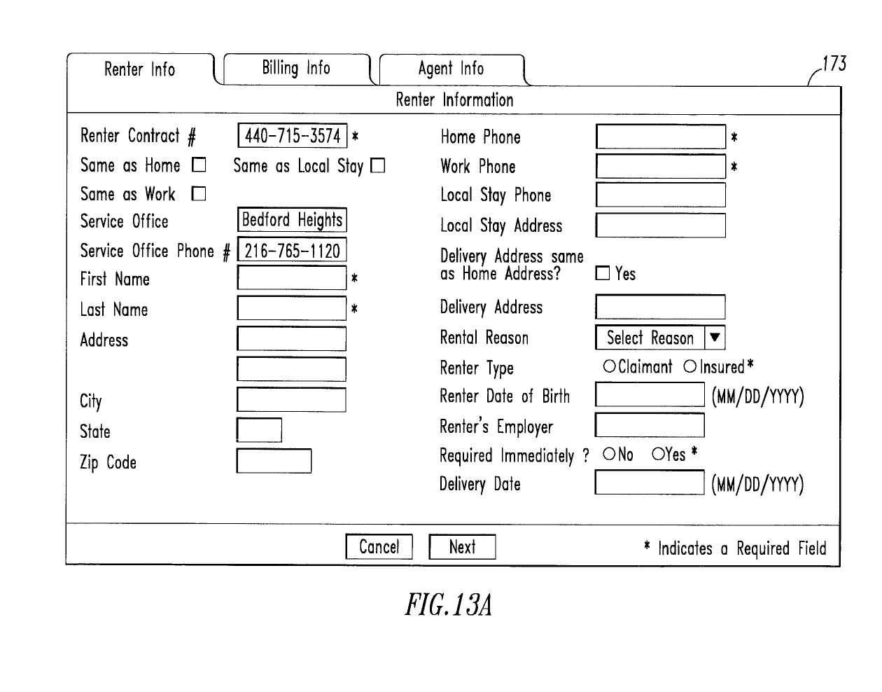

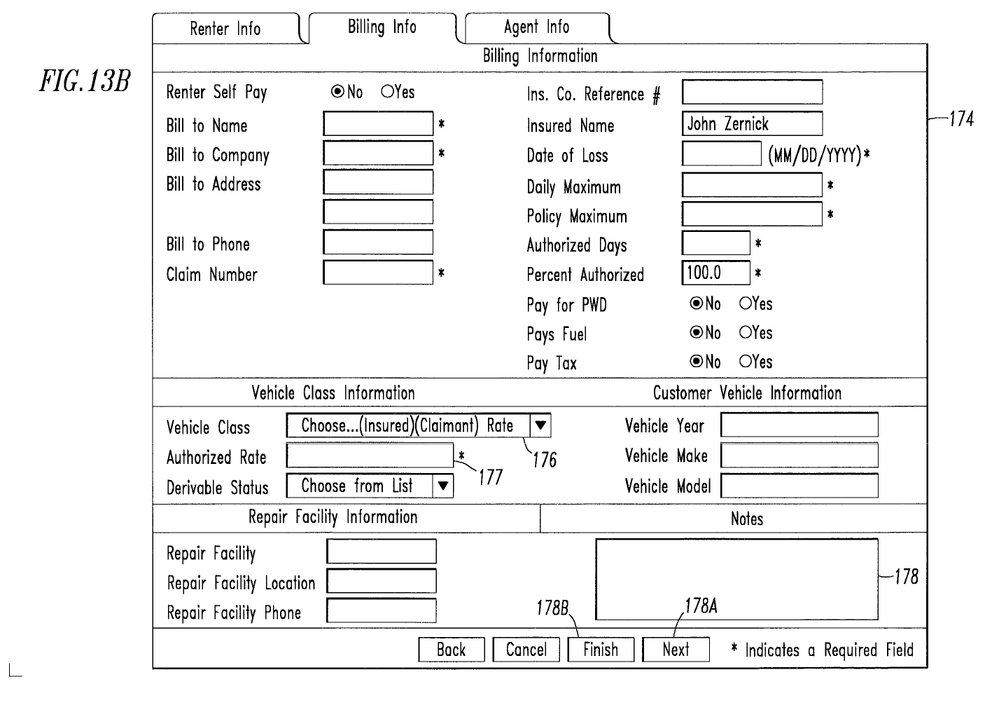

In order to create a new reservation, the user enters the renter's area code and 7-digit telephone number 152, in order to book a new reservation for a vehicle rental, and then chooses either the Express Reservation button 154 or the Full Reservation button 156, in order to request the respective data entry forms of FIGS. 12 and 13A-13C. The system, in turn, searches the database 98 of FIG. 9 for the closest available servicing branch office to the renter and routes the reservation to that particular branch.

The system 80 of FIG. 9 maintains the database 98 of rental variables 100 and claim files 110, which are associated with the unconfirmed reservations 161, the pending reservations 163, the open vehicle rentals 165, and the closed vehicle rentals 167.

The home page 150 of FIG. 11, which is displayed on one or both of the client systems 90,92 of FIG. 9, includes a scoreboard 158 including counts 160,162,164,166,168,170 of respective unconfirmed rental reservations 161, pending reservations 163, open rentals 165, closed rentals 167, incoming messages 169, and invoices 171 of FIG. 9. Unconfirmed reservations are ones, which have been initiated by the user, but which the responsible branch office has yet to accept. Pending reservations are rentals that have been accepted by the vehicle rental service provider, but the customer has yet to get into the rental vehicle. Open rentals are rentals where the renter is actually in the vehicle.

Closed rentals are rentals where the customer has returned the vehicle. Although the exemplary scoreboard 158 shows a count of zero for Closed Rentals, the system gives the user the opportunity through the settings bar 171 to indicate how long the user wishes the scoreboard to retain this information (e.g., a day, a week, a month, a quarter). When the user presses the button 186, a closed rentals listing (not shown) is displayed, which includes the insurance claim number, the claims adjuster's name, the renter's name, the rental number, whether the renter is a claimant or an insured party, the body shop performing the repair, the repair vehicle's year and model, the date the rental was taken out, the date the rental was returned, the number of extensions that were granted on this particular claim file, the length of the rental, an estimate of the total charges, and a button to view the invoice.

Incoming messages are any messages from a rental branch office (e.g., an extension request for the additional rental period). Invoices may be printed on demand.

Continuing to refer to FIG. 11, the scoreboard 158 provides a claims adjuster or claims supervisor with a quick overview of all current rentals under the user's control. The scoreboard 158 updates to indicate any new activity. Hence, the user does not have to open a subsequent page or section in order to find out if there have been any changes to a particular claim file.

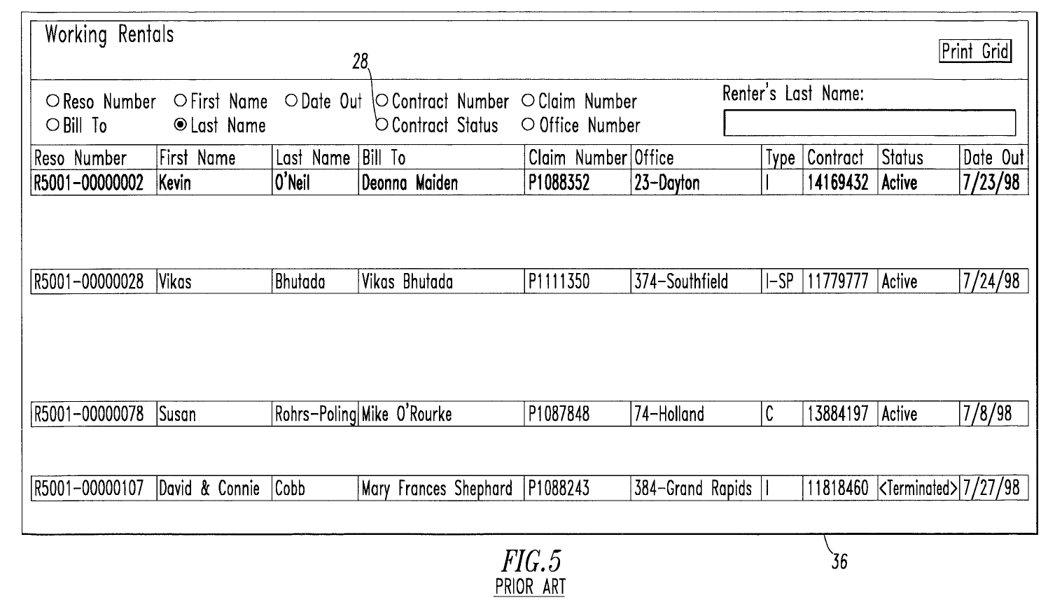

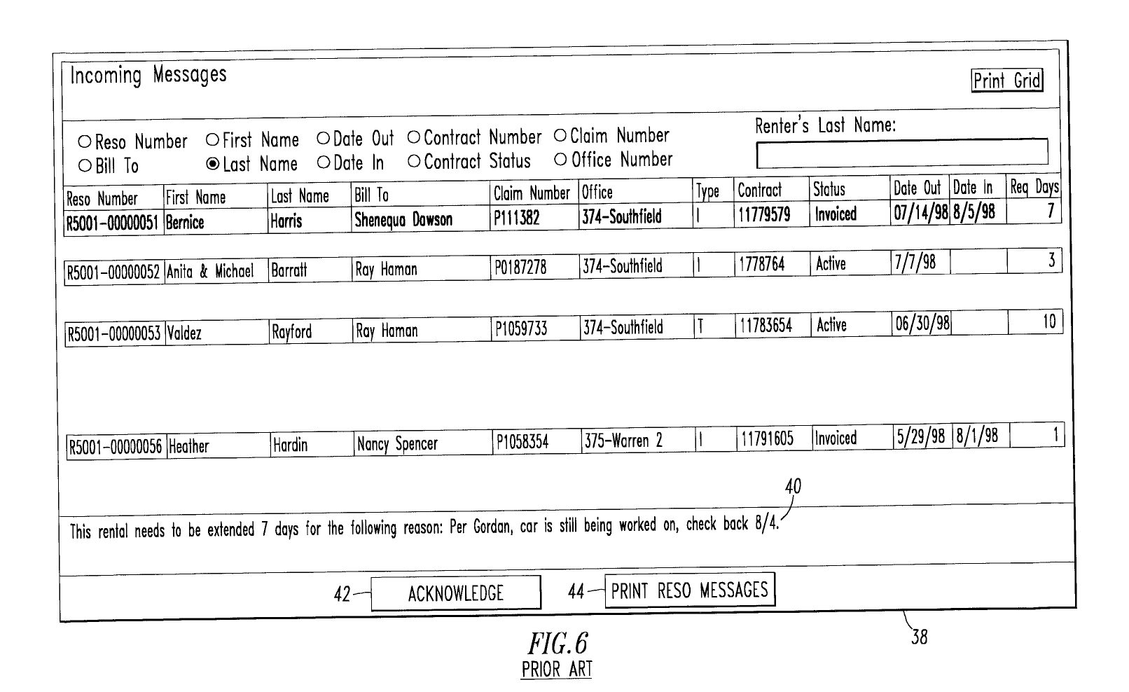

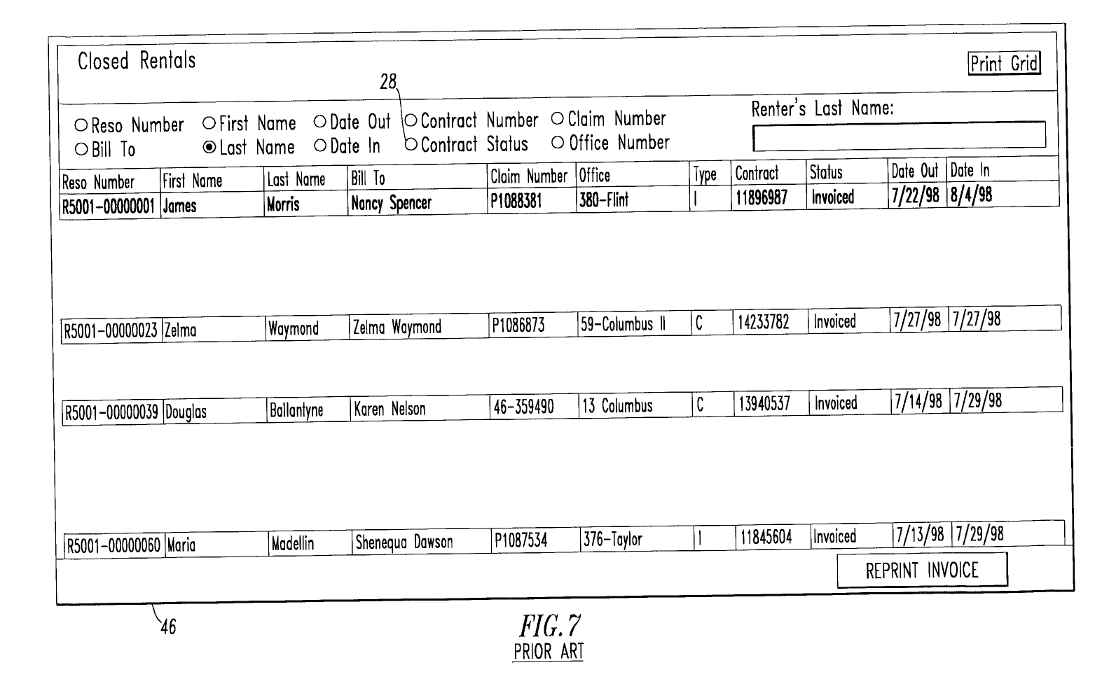

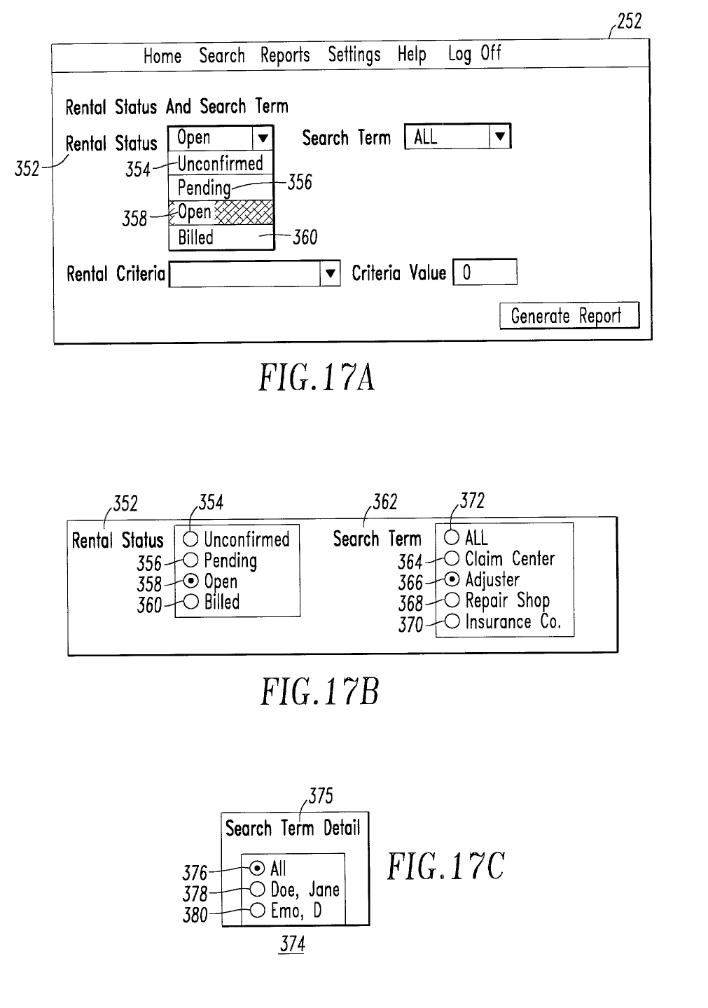

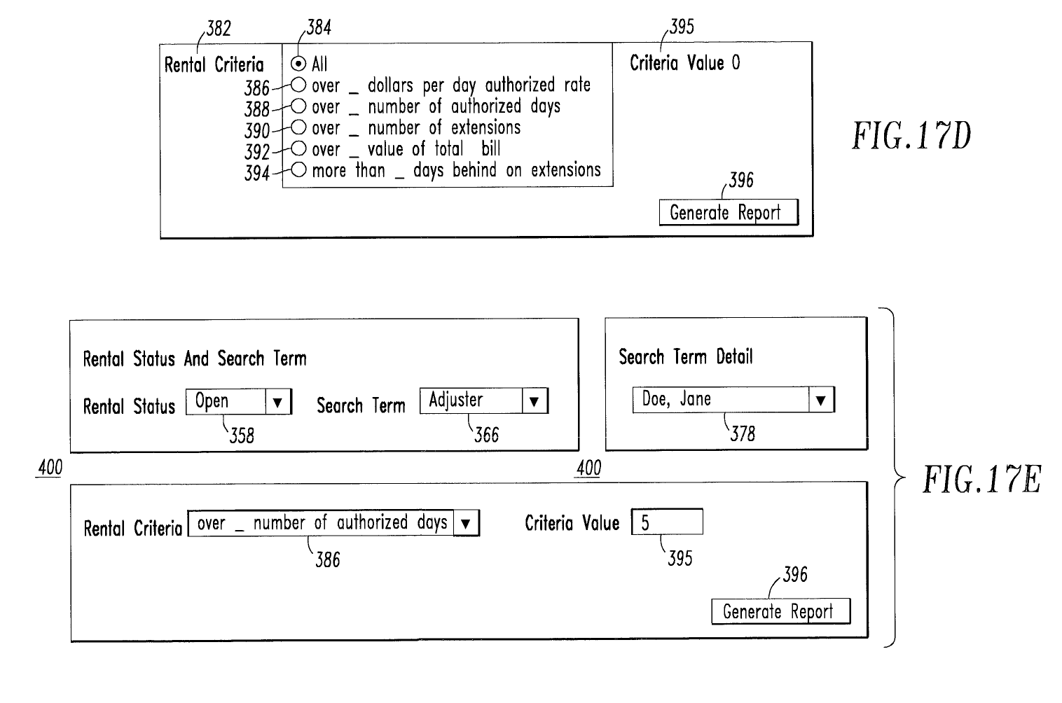

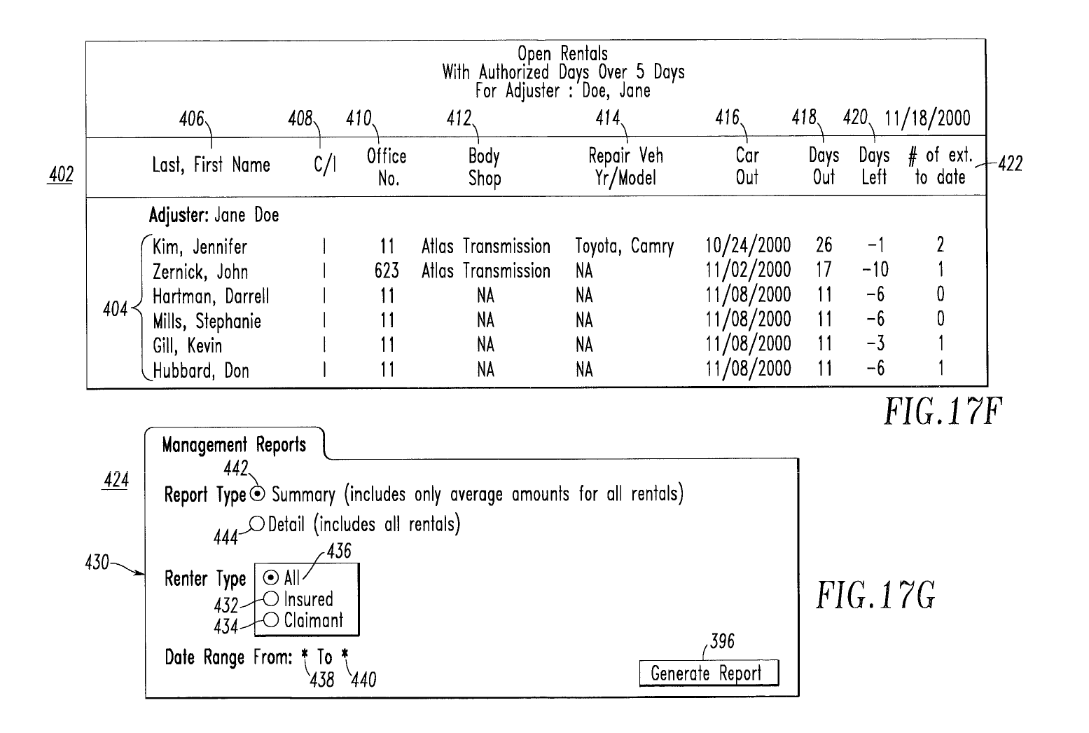

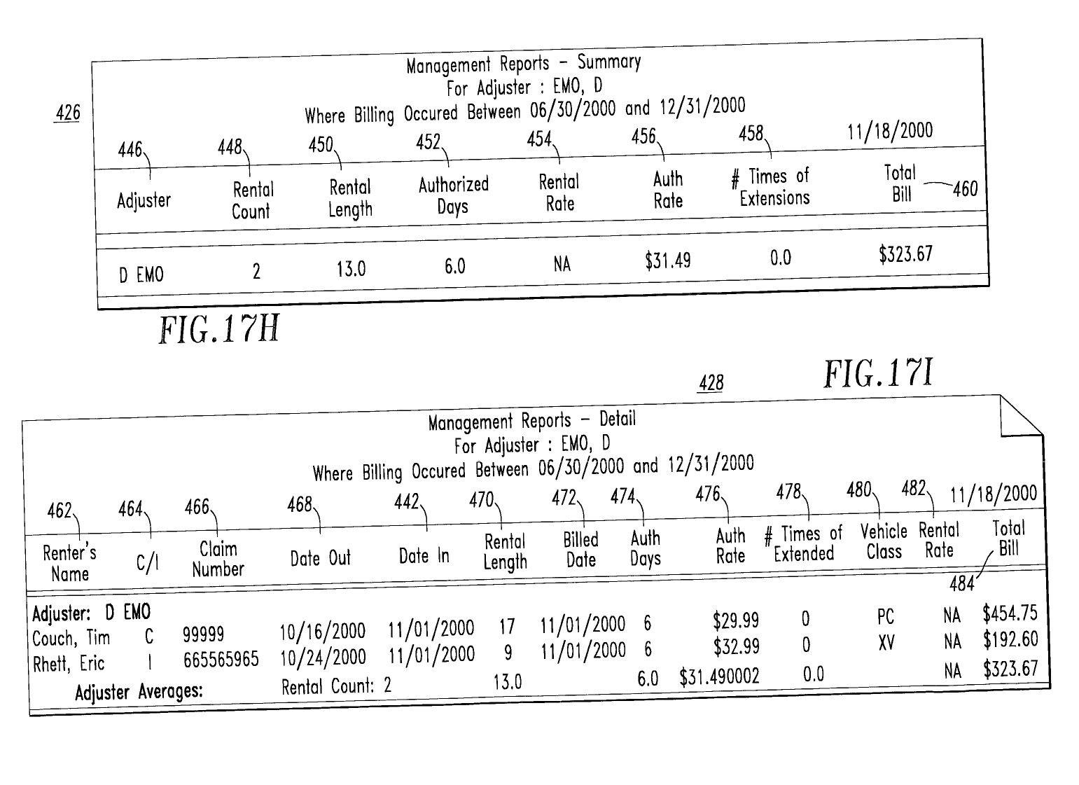

The home page 150 also contains navigations for searching (FIG. 6), reporting (FIGS. 17A-17I), settings, help functionality, and logging-off the system.

FIG. 12 shows the express reservation form 172, which provides an abbreviated form, with respect to the three full reservation forms 173,174,175 of FIGS. 13A-13C. The first page or form 173 includes renter information; the second page or form 174 includes billing information, vehicle class information, customer vehicle information, repair facility information, and notes; and the third page or form 175 includes agent and policy information. The system pre-fills some of the available information (e.g., the servicing branch for the rental, the telephone number of the renter, the telephone number of the servicing branch). In the exemplary display, there are fields that need to be completed before submitting the reservation. The asterisks indicate an exemplary required field and these fields change depending whether the user is an insured or a claimant, or whether there was an accident or a theft. As another example, the system defaults to accident, although a drop-down box indicates any of the various reasons why the user might need a rental vehicle (e.g., corporate, business, loss of use, theft, recovered theft).

In FIG. 12, renter type can either be a claimant or an insured. Daily maximum (e.g., $25 per day) and policy maximum (e.g., $500) are for insured rentals, which are not on claimants. Vehicle classes include rates and various cars based on, for example, negotiated rates.

The entry fields of FIG. 13B permit the selection of the class of vehicle 176 (e.g., a full size car) and the authorized rate 177 (e.g., $25 per day). Alternatively, the rate field 177 may be pre-filled based upon a daily maximum on insurance. The billing notes section 178 provides an opportunity for the user to communicate to the branch office. For example, it might state that “The customer would like a call at 10:00 a.m., please.” That message is, in turn, conveyed to the branch office. Upon completion of the mandatory fields, the reservation may be sent by clicking Next 178A, after which the reservation is processed. If after review, any changes are made, then by clicking Finish 178B, the reservation is routed to one of the rental branches in the nearest servicing area. At this point, the user is directed back to the home page 150 of FIG. 11 in order to begin managing the active rental process.

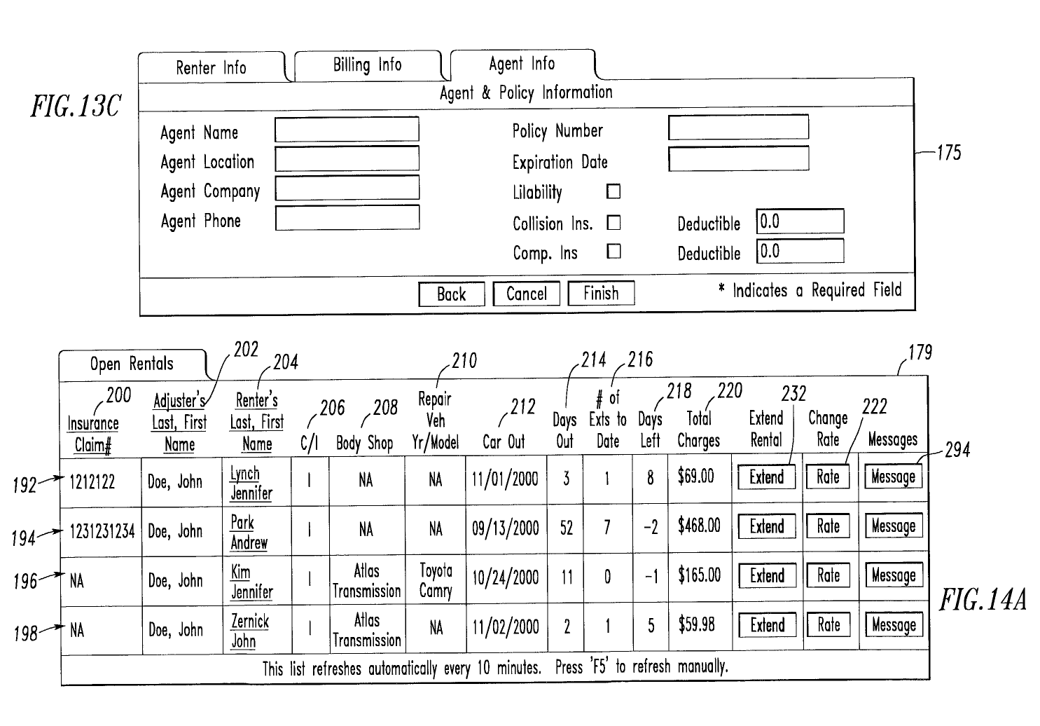

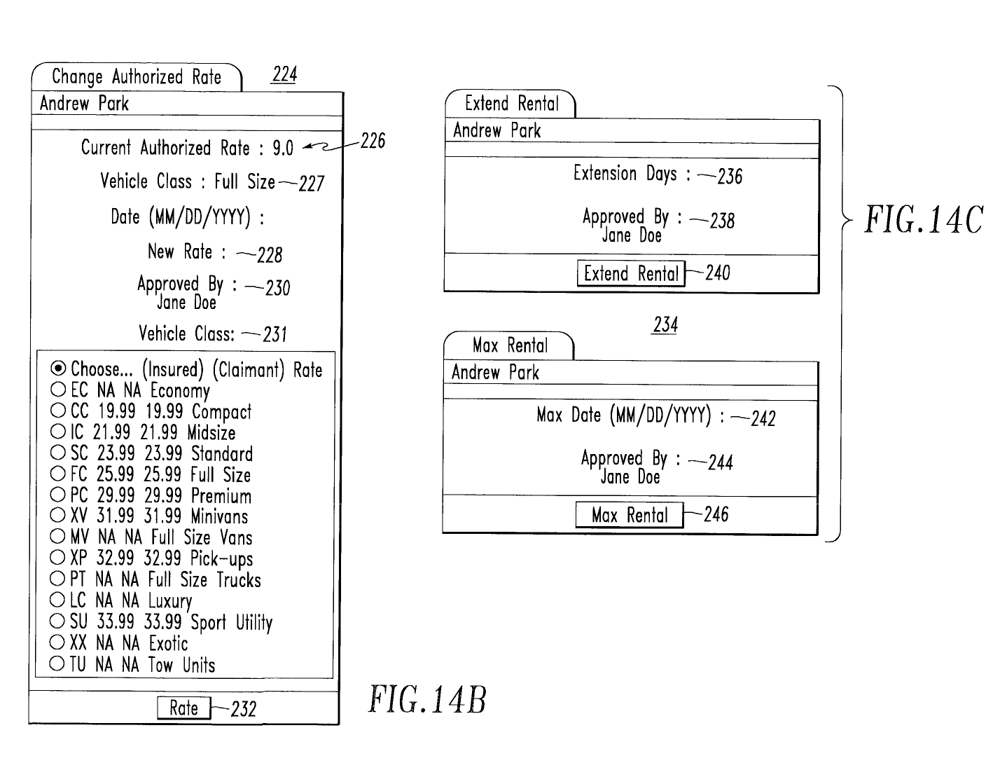

FIG. 14A shows the open vehicle rentals listing 179. For example, from the home page 150 of FIG. 11, if the user chooses one of the buttons 180,182,184,186,188,190, such as 184, from the scoreboard 158, the user gets a listing, such as the open vehicle rentals listing 179. This enables the user to review the details of a vehicle reservation and permits editing and updating of the vehicle rental claim file in the database 98 of FIG. 9. The open vehicle rentals listing 179 permits the claims adjuster or claims manager to effectively manage the claims process.

For example, as shown in FIG. 14A, the exemplary listing 179 includes four open rentals 192,194,196,198, each of which includes exemplary vehicle rental variables, such as insurance claim number 200, name of claims adjuster 202, name of renter 204, a designation 206 of claimant (C) or insured (I), name of repair body shop 208, year and model of vehicle under repair 210, date that the rental vehicle was rented 212, number of days that the rental vehicle has been rented 214, number of extensions that have been granted on the rental to this point 216 by the claims adjuster, the number of days left on the current extension 218, and the total charges on the vehicle rental to date 220. By clicking on one of the renter's names, the system redisplays the corresponding initial reservation page 172 of FIG. 12.

A vehicle out date 212 is associated with each of the open rentals. Later, when the vehicle is returned and when the corresponding open rental is closed, the vehicle out date 212 and a vehicle in date (not shown) are associated in the database 98 of FIG. 9 with each of the closed rentals.

Whenever the user presses a Rate button, such as 222 for rental 192, a popup window 224 of FIG. 14B is displayed which includes the current rate information 226 (e.g., $29.99 per day) for the open rental, as well as a rate entry field 228 and a field 230 to authorize the rental rate change, in response to the Rate button 232, for that rental. This permits the claims adjuster to change the authorized rate, if, for example, the customer needs a van for the weekend or is going on a trip and needs a different vehicle. Thus, the claims adjuster may first see the current rate 226 and class 227, and then enter the new rate 228 and vehicle class 231.

Whenever the user presses an Extend button, such as 232 for rental 192 of FIG. 14A, a pop-up window 234 of FIG. 14C is displayed which includes a field 236 to change the number of days of the extension, a field 238 to authorize the change of the expected rental duration, in response to the button 240, for that rental. For example, where the current expected duration 218 (e.g., 8 days) for the open rental 192 of FIG. 14A, the field 236 (e.g., 3), may be employed to extend that duration. The window 234 also includes a field 242 to limit the maximum date of the rental, and a field 244 to authorize the change of the maximum rental duration, in response to the button 246, for that rental.

Preferably, the system automatically sorts and puts rentals that are the furthest behind at the top of the list of FIG. 14A. This can be modified by clicking at the top of the selected column. This gives the claims adjuster the opportunity to either extend the rental or change the authorized rate. For example, if the days left 218 is 2 and the number of extensions 216 is 7, and if there is an extension of 5 days, then upon refresh, the days left 218 becomes 3 days and the number of extensions 216 is incremented to 8.

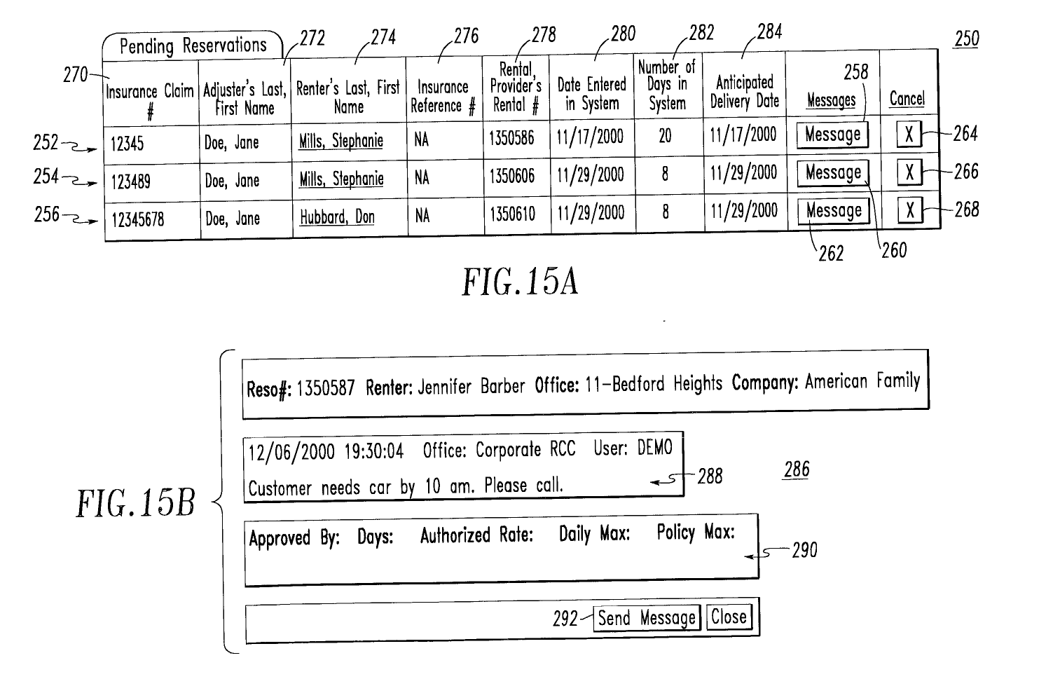

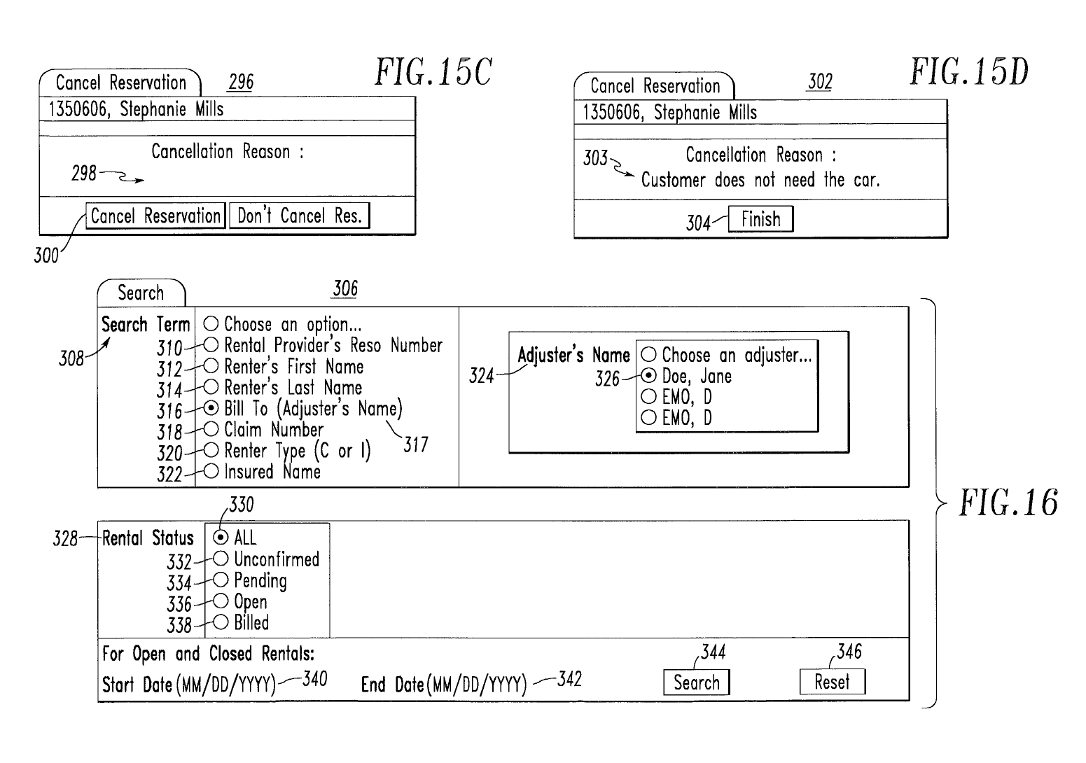

FIG. 15A shows a pending reservations listing 250. For example, from the home page 150 of FIG. 11, if the user chooses the button 182 from the scoreboard 158, the system displays the listing 250. This shows the pending reservations 252,254,256 and permits the user to display corresponding messages from the respective message buttons 258,260,262 and/or cancel such reservations from the respective cancel buttons 264,266,268. The pending reservations listing 250 provides information such as, for example, insurance claim number 270, adjuster's name 272, renter's name 274, insurance reference number 276, the rental number 278, the date 280 the reservation was entered into the system, the number of days 282 in the system, and the anticipated delivery date 284. Based upon the number of days in the system and the anticipated delivery date, a message (not shown) may be sent by the system to inquire about the status of the pending reservation (e.g., “Did the customer cancel?”).

For example, in response to the user pressing one of the message buttons 258,260,262, the system displays the pop-up window 286 of FIG. 15B from which prior messages, such as 288, are displayed and new messages may be entered at 290 and sent in response to the Send Message button 292. In a like manner., pressing one of the message buttons, such as 294, of FIG. 14A, initiates the display of one or more messages associated with one of the open rentals. In response to the user pressing one of the cancel buttons 264,266,268, the system displays the pop-up window 296 of FIG. 15C. In turn, the user may enter a cancellation reason at 298, and then press the Cancel Reservation button 300. In response, the system displays the pop-up window 302 of FIG. 15D, which displays the cancellation reason 303 (from field 298 of FIG. 15C) after which the user completes the cancellation step by pressing the Finish button 304.

FIG. 16 shows the search screen 306, which allows the user to search for renter claim files by various search terms 308 including rental number 310, renter's first name 312, renter's last name 314, the bill to party 316, such as the claims adjuster's name 317, claim number 318, renter type (C or I) 320, and insured's name 322. The system maintains the database 98 of FIG. 9 for each of the vehicle rentals. The database 98 associates, for example, one of the claims adjusters with each of the vehicle rentals in the database. When the user specifies the search term as “Bill To (Adjuster's Name),” as selected at 316, the search screen 306 is updated to permit the user to select one of the claims adjusters 324 (e.g., Jane Doe 326). Also, the display permits the user to specify the rental status 328: all 330, unconfirmed 332, pending 334, open 336, and billed 338 (or invoiced). Also, for open and closed rentals, the user may specify the start date 340 and the end date 342. In turn, the user may press the Search button 344 to initiate the search request, or the Reset button 346 to display the initial search screen 306. In response to the exemplary search request of FIG. 16, the system searches the database 98 for the vehicle rentals, which are associated with the selected one of the claims adjusters 324, and returns a summary display of corresponding vehicle rentals (not shown).

For example, if the search is commenced by clicking on the renter's last name 314, the system provides different informational entry fields (not shown) including: the renter's last name, and the rental status (i.e., unconfirmed, pending, open, billed). In this manner, the system reduces the amount of data that the user has to review. The user may also specify the start date 340 and the end date 342, if that information is known. In turn, the system returns information from one or more claim files. This permits the claims adjuster to quickly obtain that information and, thus, for example, answer questions or review bills.

FIG. 17A shows the report screen 350, which allows the user (e.g., a supervisor, at any level; a manager over a plurality of claim is adjusters; a claims office supervisor over an entire building; executive management over an entire country) to generate 84 different exemplary reports, and permits the user to look at situations as they unfold to prevent problems, rather than merely reacting to them after they have occurred. The user first selects the rental status 352: unconfirmed 354, pending 356, open 358, or billed 360. Most of the important management reporting capabilities are typically in the open or billed statuses. In order to prevent problems before they occur, the user looks at the open rentals 358. With that selection, as shown in FIG. 17B, the search term 362 is by claims center 364, by adjuster 366, by repair shop 368, by insurance company 370, or by all 372 of those selections. Thus, for example, if the user selects adjuster 366, a drop-down box 374 is displayed (FIG. 17C) that permits the selection of search term details 375 including all adjusters 376 or a single adjuster, such as 378,380. Similarly, if the user chooses claims center 364, repair shop 368, or insurance company 370, then the system displays a drop-down box (not shown) that shows the different claims centers, repair shops, or claims adjusters, respectively, under that particular party's control. For example, executive management might have ten different claims centers and, thus, would have the opportunity to look at any one or all of those particular claims centers.

Next, the user selects the rental criteria 382 (FIG. 17D) and has the opportunity to select any one of the different values: all rentals 384, any rental that is a certain number of dollars per day over the authorized rate 386, any rental that is over a certain number of authorized days 388, any rental that is over a certain number of authorized extensions 390, any rental that is over a certain dollar value of the total bill 392, and any rental that is more than a certain number of days behind on extensions 394.

If the user selected unconfirmed reservations 354 of FIG. 17B, then the user may initiate the generation of six different reports regarding the unconfirmed reservations in the database 98 of FIG. 9, including the following selections: (1) all 372 (i.e., the vehicle rental service provider), (2) a claims center of the insurance service provider 364, (3) all of the claims adjusters 366 and 376 (FIG. 17C), (4) a selected one of the claims adjusters 366 and 378 or 380 (FIG. 17C), (5) a selected vehicle repair shop 368, and (6) the insurance service provider 370. Similarly, the user may initiate the generation of six different reports for such selections regarding the pending reservations in the database 98. Although additional rental criteria are possible for the open rentals and the billed rentals, by selecting all 384 of FIG. 17D, for either open rentals or billed rentals, the user may similarly initiate the generation of six different reports for the six selections regarding those rentals in the database 98.

Accordingly, the user may, for example, by selecting all 372 of FIG. 17B, generate a report to provide a listing of one of: (1) all of the unconfirmed reservations; (2) all of the pending reservations; (3) all of the open rentals; or (4) all of the closed rentals in the entire system.

For the open rentals 358 selections of FIG. 17B, the user selects one of the rental variables via the rental criteria 386,388,390,392,394 selections of FIG. 17D, enters a criteria value 395 corresponding to the selected one of the rental variables, and clicks on the Generate button 396 in order to generate one of the reports including, typically, one or more of the open rentals for which the selected one of the rental variables differs from (e.g., is less than, exceeds) the entered value.

For the open rentals 358 selections of FIG. 17B, the selected rental criteria 386 is employed to show rentals over a set per day authorized rate value. A particular cost value (e.g., $29.99 per day) is input as the entered criteria value 395 of FIG. 17D. In response to the Generate Report button 396, the system generates the corresponding report.

Still considering the open rentals 358 selections, with the selected rental criteria 388, which provides a report for any rental that is over a certain number of authorized days, the system employs an authorized rental period (e.g., Authorized Days 474 of FIG. 17I) as one of the vehicle rental variables in the database 98 of FIG. 9. A particular time value (e.g., 10 days) is input as the entered criteria value 395. In response to the Generate Report button 396, the system generates the corresponding report for, typically, one or more of the open rentals for which the authorized rental period exceeds the time value.

For the rental criteria 390, which provides a report for any rental that is over a certain number of authorized extensions, the system employs a count of rental extensions (e.g., 216 of FIG. 14A) as one of the vehicle rental variables in the database 98 of FIG. 9. A particular count value (e.g., 8 extensions) is input as the entered criteria value 395. In response to the Generate Report button 396, the system generates the corresponding report for, typically, one or more of the open rentals for which the count of rental extensions exceeds the count value.

For the rental criteria 392, which provides a. report for any rental that is over a certain dollar value of the total bill, the system employs a total rental cost value (e.g., 220 of FIG. 14A) as one of the vehicle rental variables in the database 98 of FIG. 9. A particular value (e.g., $500 total cost) is input as the entered criteria value 395. In response to the Generate Report button 396, the system generates the corresponding report for, typically, one or more of the open rentals for which the total rental cost exceeds the cost value.

For the rental criteria 394, which provides a report for any rental that is more than a certain number of days behind on extensions, the system employs an extension time period (e.g., 236 of FIG. 14C) as one of the vehicle rental variables in the database 98 of FIG. 9. A particular time value (e.g., 10 days) is input as the entered criteria value 395. In response to the Generate Report button 396, the system generates the corresponding report for, typically, one or more of the open rentals for which the extension time period is less than the time value.

In this manner, the user may initiate one of 36 (=6×6) different open rentals report types based upon the six different search terms 362 and the six different rental criteria 382.

FIG. 17E shows an exemplary report screen 400, which allows the user, upon clicking on the Generate Report button 396, to initiate the generation of an open rentals report 402 (FIG. 17F) based upon the user selection of “Open” 358 as the rental status, claims “Adjuster” 366 as the search term, “Doe, Jane” 378 for the exemplary selected search term detail (e.g., the name of the selected claims adjuster), “over number of authorized days” 386 as the exemplary rental criteria, and “5” 395 as the exemplary criteria value.

In response to the request for the report, the database servers 144,146 of FIG. 10 search for the claim files, which meet the selected criteria (eg., as shown in FIG. 17E). In this example, information from six exemplary claim files 404 is returned for display in the open rentals report 402 of FIG. 17F. The exemplary report 402 includes, for each of the claim files 404, the name of renter 406, a designation 408 of claimant (C) or insured (I), the office number 410 handling the claim, the repair body shop 412, the year and model 414 of the vehicle under repair, the date that the rental vehicle was rented 416, the number of days that the rental vehicle has been rented 418, the number of days left on the current extension 420, and the number of extensions that have been granted on the rental to date 422.

FIG. 17G shows an exemplary report screen 424, which allows the user, upon clicking on the Generate Report button 396, to initiate the generation of one of various billed rental reports 426 and 428 (e.g., as shown in respective FIGS. 17H and 17I) based upon the user selection of: (1) “Billed” 360 of FIG. 17B as the rental status; (2) one of the five exemplary search terms 364,366,368,370,372 of FIG. 17B (e.g. a claims center of the insurance service provider; one or all of the claims adjusters; a vehicle repair shop; the insurance service provider; the rental service provider, respectively); and (3) one of the corresponding selected search term details 376,378,380 (e.g., the name of the selected claims adjuster of FIG. 17C).

The report screen 424 further includes search fields for selecting one or all of various renter types 430. In this example, the user may select: (1) an insured 432 renter type; (2) a claimant 434 renter type; and (3) all 436 of the renter types and, thus, generate the report for only the insured renter type, only the claimant renter type, and all of the renter types, respectively.

The report screen 424 also includes search fields for entering one or both of a starting date 438 (e.g., corresponding to a vehicle out date) and a billing date 440 (e.g., corresponding to a vehicle in date). In this manner, upon clicking the Generate Report button 396, the user may initiate the generation of one of the reports for each of the billed or closed rentals which has the vehicle out date (e.g., 416 of FIG. 17F) on or after the starting date 438 and the vehicle in date (e.g., 442 of FIG. 17I) prior to the billing date 440.

The report screen 424 further includes search fields for selecting one of a summary 442 report format and a detail 444 report format. For example, when the user selects and initiates the summary report format, the resulting summary report, such as report 426 of FIG. 17H, is generated and displayed by the system. In this example, the summary report 426 was initiated for only one of the claims adjusters “EMO, D” 380 of FIG. 17C. Alternatively, a similar report may be generated for a different claims adjuster or “All” of the claims adjusters. In turn, as shown by the exemplary report 426, these reports include, for each of the claims adjusters, one or all of an identification 446 of the selected claims adjuster(s), an average count 448 of rentals for the selected claims adjuster, an average length 450 of rentals for the selected claims adjuster, an average count 452 of the authorized rental days for the selected claims adjuster, an average 454 of the rental rate for the selected claims adjuster, an average 456 of the authorized rental rate for the selected claims adjuster, an average count 458 of extensions for the selected claims adjuster, and an average total bill 460 for the selected claims adjuster.

Also, when the user selects and initiates the detail report format, the resulting detail report, such as report 428 of FIG. 17I, is generated and displayed by the system. In this example, the detail report was initiated for only one of the claims adjusters “EMO, D” 380 of FIG. 17C. Alternatively, a similar report may be generated for a different claims adjuster or “All” of the claims adjusters. In turn, as shown by the exemplary report 428, these reports include, all of the averages from FIG. 17H. Furthermore, the report 428 includes for each of the selected claim file(s) and for each of the selected claims adjuster(s) one or all of a renter's name 462, an insured/claimant identification 464, a claim number 466, a date out 468, a date in 442, a rental length 470, a billed date 472, a count 474 of authorized days, an authorized rate 476, a count 478 of times extended, a vehicle class 480, a vehicle rental rate 482, and a total bill 484.

In this manner, the user may initiate 36 (=6×3×2) different closed rental reports, based upon the six different search terms 362, the three different renter types 430, and the two different report types 442,444.

Although not shown in the exemplary reports 426,428, under a “customer pay” option, a portion of the total invoice may be paid by the customer. For example, if one insurance company authorizes $16.00 per day (i.e., the insured rate) for a car and the customer selects a vehicle for $20.00, then the customer is responsible for not only the extra $4.00 but, also, any applicable local taxes. The customer could also elect to purchase, for example, optional collision damage waiver (CDW) and prepaid fuel (PPF). Hence, this provides a convenient report for the total charges to the claims adjuster of the vehicle rental service provider's total charges. For insured (I), both the insurance company (whose contribution is capped at $x/day) and the customer pay respective portions of the total invoice to the vehicle rental service provider. For claimant (C), the insurance company pays the total invoice, excluding CDW and PPF.

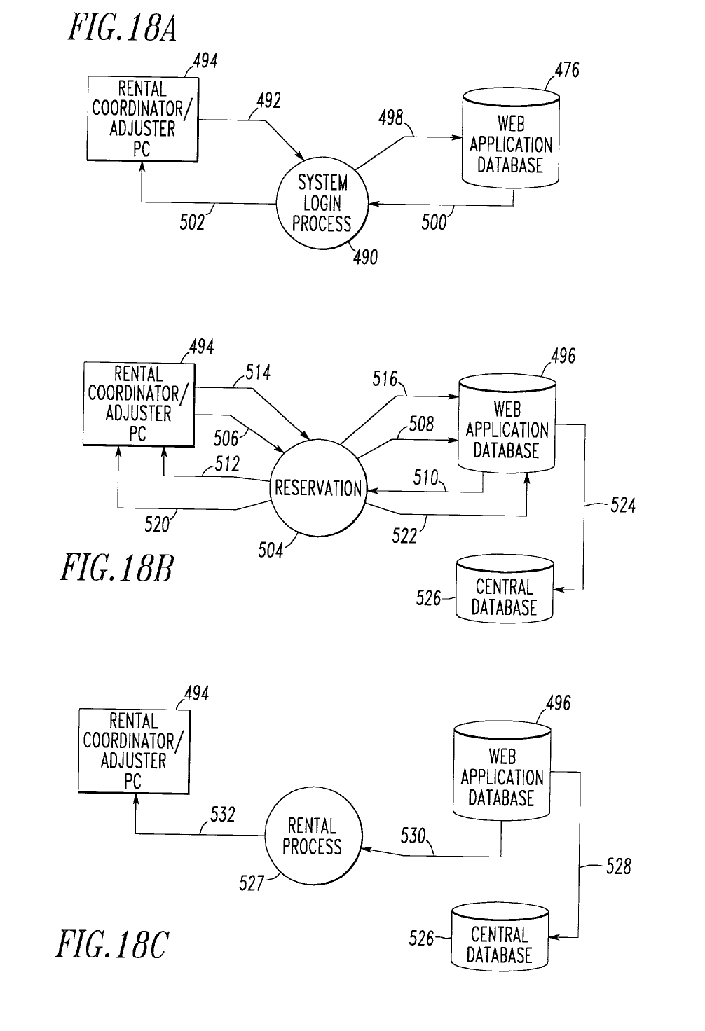

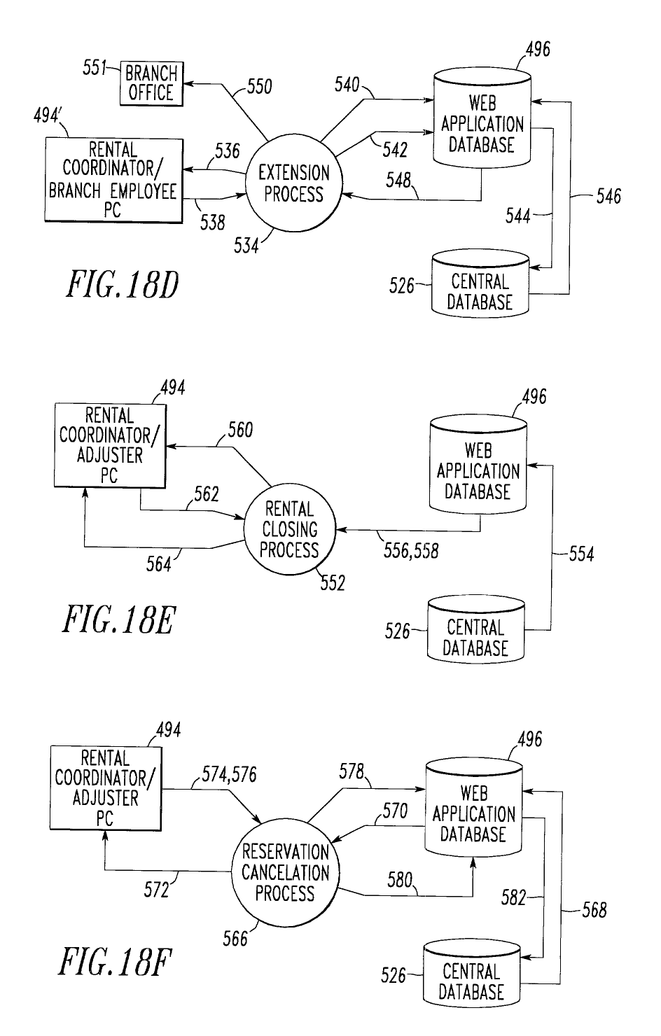

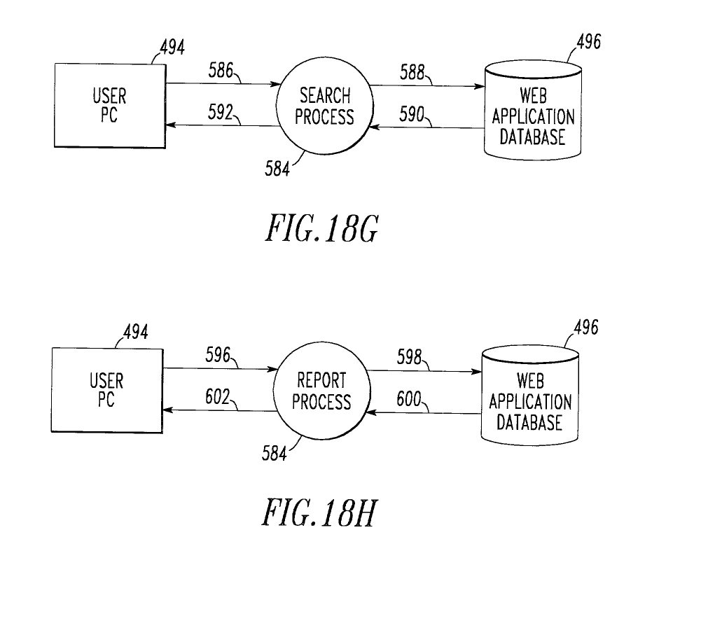

FIG. 18A shows a system login process 490 of the application servers 140,142 of FIG. 10. Initially, a login message 492, including a user name and password, is routed between the PC 494 of a user, such as a rental coordinator (RC) or claims adjuster, and the process 490. In turn, the process 490 requests information from the web application database 496 by a message 498 from the process 490 to one of the database servers 144,146 of FIG. 10, which returns a responsive message 500 to the process 490. Then, if the rental coordinator or claims adjuster have properly authenticated themselves to the system, the process 490 sends a message 502 to the user PC 494, in order to indicate that access to the web site is allowed. Alternatively, an access denied message (not shown) is sent and the initial log-in screen is redisplayed.

FIG. 18B shows a reservation process 504 of the application servers 140,142 of FIG. 10, through which a user, such as a RC or claims adjuster may enter a reservation into the vehicle rental management system. As discussed above in connection with FIG. 11, after the user enters the renter's area code and 7-digit telephone number 152 and clicks either the Express Reservation button 154 or the Full Reservation button 156, that entered information is sent to the process 504 in message 506. In turn, the process 504 sends a message 508 to one of the database servers 144,146 of FIG. 10, which searches the database 496 for the closest available servicing branch office to the renter, in order to route the reservation to that particular branch. Then, a responsive message 510 is returned to the process 504, which responsively sends a message 512 to the user PC 494, in order to display a suitable data entry form. Next, the user enters the reservation information and clicks on the Finish button 178B of FIG. 13B, which initiates the sending of message 514, including the entered rental reservation information, to the process 504. The process 504 verifies that information and sends message 516, including the reservation information, to one of the database servers 144,146. The process 504 also sends a reservation number to the user PC 494 in message 520, and a reservation message 522 to the database server, which, in turn, sends a data replication message 524, including the reservation information and number, to a central database 526.

FIG. 18C shows a vehicle rental process 527 of the application servers 140,142 of FIG. 10. Whenever there is a change in rental reservation status from, for example, a “Pending” vehicle rental to an “Open” rental, a message 528 is sent from the central database 526 to one of the database servers 144,146 of FIG. 10, in order to indicate, in this example, that a particular renter, who was scheduled to get into a vehicle, has now rented the vehicle. In turn, a suitable message 530 is sent to the process 527, in order to indicate that the reservation status has changed (e.g., from pending to open). Finally, a corresponding message 532 is sent to the user PC 494 to update the scoreboard 158 of FIG. 11.

FIG. 18D shows an extension process 534 of the application servers 140,142 of FIG. 10. The process 534 employs a first message 536 to request a vehicle rental extension from a user, such as a branch employee or RC, based upon circumstances (e.g., the customer's vehicle has not been completed during the initially authorized period) described in that message. In turn, the branch employee or RC may either approve or deny the request.

The process 534 sends the message 536 to the PC 494′ in order to request an extension of a vehicle rental. In turn, as discussed above in connection with FIG. 14C, the branch employee or RC may enter the extension period at 236, approve the request at 238, and click the Extend Rental button 240, which initiates message 538 back to the process 534. Then, the process 534 sends the reservation extension data in a message 540 to the database servers 144,146 of FIG. 10, in order update the rental variables in the database 496. Also, the process 534 sends a message 542, which is replicated and sent by the selected one of the servers in another message 544 to the central database 526.

In the event that an extension was requested by a branch office and was approved by the corresponding claims adjuster handling that file of the rental service provider, a message 546 is sent from the central database 526 to the database servers 144,146 of FIG. 10, in order update the rental variables in the database 496. In turn, the selected one of the servers sends a responsive message 548 to the process 534. The process 534, then, sends a responsive message 550 to the appropriate branch office 551 in order to inform the user that an extension was approved by a claims adjuster.

FIG. 18E shows a rental closing process 552 of the application servers 140,142 of FIG. 10, which informs a user that a vehicle was returned and that the vehicle rental is closed, in order that the user may initiate the printing of an invoice. When a vehicle is returned, that information is reflected in the central database 526, which sends a message 554 to the database servers 144,146 of FIG. 10, in order to update the rental variables in the database 496. In turn, the selected one of the servers sends a responsive message 556 and an invoice 558 for the closed vehicle rental to the process 552. The process 552, then, sends a suitable message 560 to the appropriate user PC 494, in order to update the scoreboard 158 of FIG. 11. In turn, the user may request (e.g., by clicking a View button associated with a particular rental on the Closed Rentals screen (not shown)) to print the invoice. In response, the PC 494 sends a request message 562 to the process 552, which responsively sends the invoice 564 to the PC 494.

FIG. 18F shows a reservation cancellation process 566 of the application servers 140,142 of FIG. 10, which permits a reservation to be cancelled by a user, such as a claims adjuster or RC, or which informs a user of a cancellation of a particular vehicle reservation by a branch office of the vehicle rental service provider. When a reservation is cancelled, that information is reflected in the central database 526, which sends a message 568 to the database servers 144,146 of FIG. 10, in order to update the rental variables in the database 496. In turn, the selected one of the servers sends a responsive message 570 to the process 566 for the cancelled reservation. The process 566, then, sends a cancellation message 572 to the appropriate user PC 494, in order to inform the user that a vehicle reservation was cancelled.

As discussed above in connection with FIGS. 15C and 15D, the user may enter, at 298, a cancellation reason, press the Cancel Reservation button 300, and, after review of the cancellation reason 303, press the Finish button 304. In response, the PC 494 sends a cancellation request message 574 and a cancellation data message 576 to the process 566. The process 566 responsively sends the cancellation data in message 578 to the database servers 144,146 of FIG. 10, in order to update the rental variables in the database 496. Also, the process 566 sends a cancellation message 580, which is replicated and sent by the selected one of the servers in another message 582 to the central database 526.

FIG. 18G shows a search process 584 of the application servers 140,142 of FIG. 10, which permits a user to initiate a search of the database 496 as discussed above in connection with FIG. 16. After defining the search strategy, the user clicks on the Search button 344. In response, the PC 494 sends a search message 586 to the process 584, which responsively sends a corresponding message 588 to one of the application servers 140,142. The selected server retrieves the search information from the database 496 and sends a responsive message 590 to the process 584. In turn, the process sends message 592 to the user PC 494 in order to display the search results.

FIG. 18H shows a report process 594 of the application servers 140,142 of FIG. 10, which permits a user to initiate a report from the database 496 as discussed above in connection with FIGS. 17A-17I. After defining the report format, the user clicks on the Generate Report button 396. In response, the PC 494 sends a report message 596 to the process 594, which responsively sends a corresponding message 598 to one of the application servers 140,142. The selected server retrieves the report information from the database 496, calculates averages (if a summary report was requested), and sends a responsive message 600 to the process 594. In turn, the process sends message 602 to the user PC 494 in order to display the report.

The exemplary rental management system 120 is a web-enabled, vehicle rental management tool for claims adjusters at an insurance company to utilize in communication with a vehicle rental service provider. This management tool allows all “interested” parties to remotely review, edit and/or update a particular vehicle rental claim file. The vehicle rental management system 120 eliminates phone traffic between the insurance company and the vehicle rental service provider, thereby leveraging claims adjusters' and claims managers' time and productivity. The reporting capability of the system 120 allows management at any level to review files by exception (e.g., over x number of days or extensions) to eliminate problem vehicle rentals before they occur. Without this tool, insurance companies are only made aware of a “problem” claim file as the invoice is submitted, which is too late to take any suitable corrective action. With this system 120, management can intervene, as necessary, to reduce vehicle rental severity before the vehicle rental is concluded.

The exemplary vehicle rental management systems 80,120 employ an online invoicing capability that allows claims adjusters to print and pay rental bills as soon as the vehicle is returned, thereby significantly reducing the insurance company's “open claim files”. Furthermore, the exemplary search function, which is available to the claims adjusters, eliminates the need to call or write for duplicate copies of correspondence.

Moreover, the report function gives claims adjusters instant access to all communications between the vehicle rental service provider, the repair facility, and the insurance company on all open and closed rental files. The reporting function can alert the user as to when rental claim files have exceeded a certain dollar value, a certain number of days, a certain number of extensions, or a certain authorized rate. It allows a supervisor to manage by exception and look at areas where problems exist (e.g., at a particular body shop, by a particular claims adjuster, by a particular area of the country). This allows a particular claims loss to be controlled as it happens, not after it happens. Hence, both claims adjusters and management may look at each claim file and manage strictly by exception without having to look at everything in order to find the area(s) of greatest problem. The system also facilitates communications between claims centers and branch offices of the rental vehicle service provider, assists claims adjusters with rental management, and provides a wide variety of management and billing reports designed to stop rental problems before they occur.

While for clarity of disclosure reference has been made herein to the exemplary PCs 90,92 for displaying reports, search results, and other reservation and rental-related information, it will be appreciated that all such information may be stored, printed on hard copy, be computer modified, be combined with other data, or be transmitted for display elsewhere. All such processing shall be deemed to fall within the terms “display” or “displaying” as employed herein.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

We claim:

1. A method for managing rentals from a rental service provider by an insurance service provider having a plurality of claims adjusters and claims managers, said method comprising:
employing a server system including a database having rental claim information for each of said rentals;
of employing a plurality of client systems for said claims adjusters and said claims managers;
employing a global communication network to interconnect said server system with said client systems;
displaying at least some of said rental claim information for one of said rentals at one of said client systems;
modifying said rental claim information for said one of said rentals from said one of said client systems; and
reviewing by exception some of said rental claim information from another one of said client systems.

2. The method of claim 1 further comprising
entering rental reservations; and
displaying at one of said client systems a scoreboard including a count of unconfirmed rental reservations.

3. The method of claim 1 further comprising
displaying at one of said client systems a list of open rentals;
including rate information with said open rentals; and
changing a rate for one of said open rentals.

4. The method of claim 3 further comprising
providing an expected duration for one of said open rentals; and
extending said expected duration.

5. The method of claim 3 further comprising
displaying a message associated with one of said open rentals.

6. The method of claim 2 further comprising
displaying said scoreboard including counts of pending reservations, open rentals, closed rentals, incoming messages, and invoices.

7. The method of claim 6 further comprising
displaying said pending reservations; and
canceling one of said pending reservations.

8. The method of claim 1 comprising
providing a plurality of unconfirmed reservations; and
generating a plurality of reports regarding said unconfirmed reservations.

9. The method of claim 8 comprising
generating one of said reports for one of said insurance service provider, a claims center of said insurance service provider, one of said claims adjusters, all of said claims adjusters, a vehicle repair shop, and said rental service provider.

10. The method of claim 1 comprising
providing a plurality of pending reservations; and
generating a plurality of reports regarding said pending reservations.

11. The method of claim 10 comprising
generating one of said reports for one of said insurance service provider, a claims center of said insurance service provider, one of said claims adjusters, all of said claims adjusters, a vehicle repair shop, and said rental service provider.

12. The method of claim 1 comprising
providing a plurality of open rentals; and
generating a plurality of reports regarding said open rentals.

13. The method of claim 12 comprising
generating one of said reports for one of said insurance service provider, a claims center of said insurance service provider, one of said claims adjusters, all of said claims adjusters, a vehicle repair shop, and said rental service provider.

14. The method of claim 12 comprising
maintaining a database of rental variables associated with each of said open rentals;
selecting one of said rental variables;
entering a value corresponding to said selected one of said rental variables; and
generating one of said reports including at least some of said open rentals for which said selected one of said rental variables exceeds said entered value.

15. The method of claim 14 comprising
employing an authorized rental rate and an actual rental rate as some of said rental variables;
employing a cost value as said entered value; and
generating said one of said reports including at least some of said open rentals for which said actual rental rate exceeds said authorized rental rate.

16. The method of claim 14 comprising
employing an authorized rental period as one of said rental variables;
employing a time value as said entered value; and
generating said one of said reports including at least some of said open rentals for which said authorized rental period is less than said time value.

17. The method of claim 14 comprising
employing a count of rental extensions as one of said rental variables;
employing a count value as said entered value; and
generating said one of said reports including at least some of said open rentals for which said count of rental extensions exceeds said count value.

18. The method of claim 14 comprising
employing a total rental cost as one of said rental variables;
employing a cost value as said entered value; and
generating said one of said reports including at least some of said open rentals for which said total rental cost exceeds said cost value.

19. The method of claim 14 comprising
employing an extension time period as one of said rental variables;
employing a time value as said entered value; and
generating said one of said reports including at least some of said open rentals for which said extension time period exceeds said time value.

20. The method of claim 1 comprising
providing a plurality of billed rentals; and
generating a plurality of reports regarding said billed rentals.

21. The method of claim 20 comprising
generating one of said reports for one of said insurance service provider, a claims center of said insurance service provider, one of said claims adjusters, all of said claims adjusters, a vehicle repair shop, and said rental service provider.

22. The method of claim 20 comprising
generating a summary report including, for each of said claims adjusters, at least some of: an identification of one of said claims adjusters, an average count of rentals, an average length of rentals, an average count of authorized days, an average rental rate, an average authorized rental rate, an average count of extensions, and an average total bill.

23. The method of claim 22 comprising
generating a detail report including, for each of said rentals and for each of said claims adjusters, at least some of: a renter's name, an insured/claimant identification, a claim number, a date out, a date in, a rental length, a billed date, a count of authorized days, an authorized rate, a count of times extended, a vehicle class, a vehicle rental rate, and a total bill.

24. The method of claim 20 comprising
employing a plurality of renter types; and
generating said one of said reports for one of said renter types.

25. The method of claim 24 comprising
employing insured and claimant as said renter types.

26. The method of claim 24 comprising
generating said one of said reports for all of said renter types.

27. The method of claim 20 comprising
entering a starting date and a billing date; and
generating said one of said reports for each of said billed rentals which has said vehicle out date on or after said starting date and said vehicle in date prior to said billing date.

28. The method of claim 1 comprising
entering a starting date and an ending date; and
generating said one of said reports for each of said closed rentals which has said vehicle out date on or after said starting date and said vehicle in date prior to said ending date.

29. The method of claim 1 comprising
employing a plurality of open rentals and closed rentals;
employing a vehicle out date associated with each of said open rentals; and
employing a vehicle out date and a vehicle in date associated with each of said closed rentals.

30. The method of claim 1 comprising
maintaining a database for each of said vehicle rentals;
associating one of said claims adjusters with each of said vehicle rentals in said database;
selecting one of said claims adjusters; and
searching said database for said vehicle rentals, which are associated with said selected one of said claims adjusters.

31. The method of claim 1 comprising
providing a plurality of unconfirmed reservations; and
providing a listing of all of said unconfirmed reservations.

32. The method of claim 31 comprising
providing (a) a plurality of pending reservations, (b) a plurality of open rentals, and (c) a plurality of closed rentals; and
providing a listing of all of one of (a) said pending reservations, (b) said open rentals, and (c) said closed rentals.

33. A method for managing vehicle rentals from a vehicle rental service provider for a plurality of users, said method comprising:
employing a server system including a database having vehicle rental variables for said vehicle rentals;
employing a plurality of client systems for said users;
employing a global communication network to interconnect said server system with said client systems;
selecting one of said vehicle rental variables;
entering a value corresponding to said selected one of said vehicle rental variables; and
generating a report for at least one of said vehicle rentals for which said selected one of said vehicle rental variables differs from said entered value.

34. The method of claim 33 comprising
employing open vehicle rentals and closed vehicle rentals with said vehicle rental variables in said database; and
generating said report for said open vehicle rentals and said closed vehicle rentals.

35. The method of claim 34 comprising
generating said report for only one of all of said open vehicle rentals and all of said closed vehicle rentals.

36. The method of claim 33 comprising
associating vehicle rental claim files with said vehicle rentals in said database.

37. The method of claim 33 comprising
employing an authorized rental rate and an actual rental rate as some of said vehicle rental variables;
employing a cost value as said entered value; and
generating said one of said reports including at least some of said open rentals for which said actual rental rate exceeds said authorized rental rate.

38. The method of claim 33 comprising
employing an authorized rental period as one of said vehicle rental variables;
employing a time value as said entered value; and
generating said one of said reports including at least some of said open rentals for which said authorized rental period is less than said time value.

39. The method of claim 33 comprising
employing a count of rental extensions as one of said vehicle rental variables;
employing a count value as said entered value; and
generating said one of said reports including at least some of said open rentals for which said count of rental extensions exceeds said count value.

40. The method of claim 33 comprising
employing a total rental cost as one of said vehicle rental variables;
employing a cost value as said entered value; and
generating said one of said reports including at least some of said open rentals for which said total rental cost exceeds said cost value.

41. The method of claim 33 comprising
employing an extension time period as one of said vehicle rental variables;
employing a time value as said entered value; and
generating said one of said reports including at least some of said open rentals for which said extension time period exceeds said time value.

42. A system for managing vehicle rentals from a vehicle rental service provider for a plurality of users, said system comprising:
a server system including a routine and a database having vehicle rental variables associated with each of said vehicle rentals;
a plurality of client systems for said users, each of said client systems including a data entry component selecting one of said vehicle rental variables, entering a value corresponding to said selected one of said vehicle rental variables, and entering a request for a report based upon said value and said selected one of said vehicle rental variables; and
a global communication network interconnecting said server system with said client systems, said global communication network sending said request from one of said client systems to said server system, the routine of said server system generating said report for at least one of said vehicle rentals for which said selected one of said vehicle rental variables differs from said entered value, said global communication network sending said report to said one of said client systems.

43. The system of claim 42 wherein said global communication network is the Internet.

44. The system of claim 42 wherein said vehicle rental variables include an authorized rental rate and an actual rental rate; wherein said entered value is a cost value; and wherein said routine generates said one of said reports including at least some of said open rentals for which said actual rental rate exceeds said authorized rental rate.

45. The system of claim 42 wherein said vehicle rental variables include an authorized rental period; wherein said entered value is a time value; and wherein said routine generates said one of said reports including at least some of said open rentals for which said authorized rental period is less than said time value.

46. The system of claim 42 wherein said vehicle rental variables include a count of rental extensions; wherein said entered value is a count value; and wherein said routine generates said one of said reports including at least some of said open rentals for which said count of rental extensions exceeds said count value.

47. The system of claim 42 wherein said vehicle rental variables include a total rental cost; wherein said entered value is a cost value; and wherein said routine generates said one of said reports including at least some of said open rentals for which said total rental cost exceeds said cost value.

48. The system of claim 42 wherein said vehicle rental variables include an extension time period; wherein said entered value is a time value; and wherein said routine generates said one of said reports including at least some of said open rentals for which said extension time period exceeds said time value.
